(19) United States
(12) Patent Application Publication
(10) Pub. No.: US 2018/0220496 A1
(43) Pub. Date: Aug. 2, 2018

(54) ELECTRONIC OVEN WITH IMPROVED HUMAN-MACHINE INTERFACE

(71) Applicant: The Markov Corporation, Dover, DE (US)

(72) Inventors: Arvind Antonio de Menezes Pereira, Milpitas, CA (US); Leonard Robert Speiser, Los Altos, CA (US)

(73) Assignee: The Markov Corporation, Dover, DE (US)

(21) Appl. No.: 15/876,138

(22) Filed: Jan. 20, 2018

Related U.S. Application Data
(60) Provisional application No. 62/451,229, filed on Jan. 27, 2017.

(51) Int. Cl. H05B 6/64

(52) U.S. Cl. CPC H05B 6/6438; H05B 6/6444; H05B 6/6414

(57) ABSTRACT

Method and systems related to improved human-machine interfaces for electronic ovens are disclosed. Different methods for displaying information to the user are disclosed. Different methods for dividing segmentation and identification tasks between a user and a control system are disclosed. In one example, an electronic oven includes a touch display, a heating chamber for heating an item, a light sensor having a field of view of at least a portion of the heating chamber, and a microwave energy source coupled to the heating chamber. The oven also includes a computer-readable medium that stores instructions to display the portion of the heating chamber as an image on the touch display using information from the light sensor, and process a touch input on the image.

### CROSS REFERENCE TO RELATED APPLICATIONS

This application claims priority to U.S. Provisional Application No. 62/451,229, filed Jan. 27, 2017, which is incorporated by reference herein in its entirety for all purposes.

### BACKGROUND OF THE INVENTION

The user experience provided by electronic ovens has not kept pace with improvements in other consumer electronics. While modern telephones are worlds apart from telephones of just ten years ago, the interface of and user experience provided by electronic ovens have not improved to any appreciable degree over the last fifty. The user interfaces of electronic ovens have been criticized by user experience professionals for decades. Criticisms are leveled at the inclusion of buttons for features that are rarely, if ever, used and counterintuitive processes for features that are used every day. Furthermore, most electronic ovens offer basic controls for a level of heat in the chamber and a job time for a user specified heat task, but channels for providing additional customized commands to the electronic oven are not widely available.

### SUMMARY

Methods and systems regarding human-machine interfaces are disclosed. In one approach, an electronic oven is disclosed. The electronic oven includes a touch display, a heating chamber for heating an item in the electronic oven, and a light sensor having a field of view. At least a portion of the heating chamber is in the field of view. The electronic oven also includes a microwave energy source coupled to the heating chamber. The electronic oven also includes a non-transitory computer-readable medium that stores instructions to: display the portion of the heating chamber as an image on the touch display using information from the light sensor, and process a touch input on the image. The light sensor is one of an infrared light sensor and a visible light sensor.

In another approach, a method for identifying an item in a heating chamber of an electronic oven is disclosed. Each step of the method is conducted by a controller of the electronic oven. The method comprises receiving information from a light sensor. The light sensor has a field of view. The field of view includes at least a portion of the heating chamber. The method also comprises segmenting an item in the heating chamber using the information from the light sensor. The method also comprises displaying a selection indicator on the item using a display. The method also comprises generating, while the selection indicator is displayed, a prompt for one of: (i) an identification of the item; and (ii) a heating instruction for the item. The method also comprises receiving a response to the prompt. The method also comprises storing the response in association with a location in the heating chamber in a memory.

In another approach, a method for identifying an item in a heating chamber of an electronic oven is disclosed. Each step of the method is conducted by a controller of the electronic oven. The method comprises receiving a trace input on a touch display. The trace input forms an encircling path. The method also comprises displaying a selection indicator on the touch display over a portion of the heating chamber based on the encircling path. The method also comprises generating, while the selection indicator is displayed, a prompt for one of: (i) an identification of the item; and (ii) a heating instruction. The method also comprises receiving a response to the prompt. The method also comprises storing the response in association with the portion of the heating chamber in a memory.

In another approach, a method for heating an item in a heating chamber of an electronic oven is disclosed. Each step of the method is conducted by a controller of the electronic oven. The method comprises determining a remaining job time for heating the item in the heating chamber. The method also comprises determining a potential human interaction and a potential remaining job time. The method also comprises providing a prompt for assistance if the remaining job time exceeds the potential remaining job time by more than a threshold. The potential remaining job time is an estimate of the remaining job time if the potential human interaction occurs.

### BRIEF DESCRIPTION OF THE DRAWINGS

FIG. 1 illustrates an electronic oven in accordance with some of the approaches disclosed herein in a closed state and an open state.

FIG. 2 illustrates various disclosed alternative approaches to the display of information concerning an item in an electronic oven on a display of the electronic oven in accordance with some of the approaches disclosed herein.

FIG. 3 includes a flow chart of a set of methods for hybrid man-machine segmenting and identifying of an item in an electronic oven in accordance with some of the approaches disclosed herein.

FIG. 4 illustrates a specific implementation of one of the methods illustrated by FIG. 3 in which a trace input is used to segment an item.

FIG. 5 illustrates a specific implementation of one of the methods illustrated by FIG. 3 in which a machine intelligence approach is used to segment an item.

FIG. 6 illustrates a specific example of how a prompt for human assistance can be provided by the electronic oven.

FIG. 7 includes a flow chart of a set of methods for training a classifier to learn a degree of interruption a human user will tolerate.

FIG. 8 illustrates a specific implementation of one of the methods illustrated by FIG. 7.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

Traditional electronic ovens have been programmed to execute basic heating tasks. The tasks could be specified using preprogrammed settings for specific foods or manually selected duration and heat intensity values. In both of these cases, a human being at some point decided and selected the behavior of the electronic oven for a given heating task. However, intelligent electronic ovens can include the ability to select the appropriate behavior for a given heating task. To achieve this goal, an electronic oven can be augmented to identify an item in the electronic oven, plan a heating task, and execute the heating task. The execution of the heating task can involve monitoring the progress of the task and readjusting the initial plan as needed.

Machine intelligence algorithms can be applied to each of the actions described in the previous paragraph. However, a small degree of human interaction can simplify the requirements of both the algorithms and hardware of the electronic oven to achieve a given level of performance. In addition, certain information such as the subjective preferences of a new user, cannot be conjured out of thin air regardless of how sophisticated a machine intelligence approach is utilized. Also, human interaction can often simplify a heating task by requesting a user to step in and physically adjust the location of items in the electronic oven, or stir items to more evenly distribute heat. As such, electronic ovens will likely benefit from a hybrid approach of machine intelligence and human intervention. Therefore, techniques that facilitate the efficient interaction of the machine and human operator are of particular importance for improving the field of electronic heating.

Various approaches disclosed herein facilitate machine-human interaction for executing a heating task in electronic oven. Some of these approaches involve novel interface elements that facilitate frictionless communication between the machine and the user as to specific items in the electronic oven. For example, some approaches provide an image of an item to the user with an overlay to emphasize that the specific item is the basis of the current communication between the machine and user. Some of the disclosed approaches decrease the required complexity of both the hardware and algorithms necessary to provide a given degree of performance by the electronic oven. For example, some approaches request user input to segment an item in the electronic oven and to obtain desired temperatures for the item but utilize machine intelligence to identify the item and plan or execute the heating task. Some of the disclosed approaches harvest data from the human-machine interaction to improve the machine intelligence algorithms of the electronic oven. As an example, a given electronic oven may request user assistance in segmenting or identifying items in the electronic oven and use the information obtained to train a classifier to segment or identify items in the future. As another example, some approaches involve machine intelligence that prompts a user to assist in a heating task and learns to not prompt a user unnecessarily based on the user's response to those prompts. The approaches include both hardware implementations, software procedures, and user interface improvements.

An electronic oven capable of executing some of the hybrid human-machine techniques disclosed herein can exhibit certain common features such as a heating chamber for heating an item in the electronic oven. The heating chamber can include at least one injection port for receiving energy from an energy source. The electronic oven can include a microwave energy source coupled to the heating chamber. The microwave energy source could be coupled to the heating chamber using a wave guide. The microwave energy source could be a magnetron. The electronic oven could also include a chamber door for providing access to the heating chamber in an open state and sealing the heating chamber in a closed state. The electronic oven could also include a light sensor having a field of view. The field of view could include at least a portion of the heating chamber. For example, the light sensor could be built into the walls or ceiling of the heating chamber and have a view of the center of the heating chamber via a discontinuity in the chamber. The discontinuity could be a waveguide past cut off to allow electromagnetic energy in the spectrum of interest for the light sensor to escape while keeping electromagnetic energy used for heating sealed in the chamber.

The electronic oven could also be augmented with user interface elements. For example, the electronic oven could include a display, such as an LCD, CRT, OLED, or plasma display. The electronic oven could also include a panel to receive control inputs from a user. The panel could include a set of buttons or dials to receive selections from the user. The selection could include durations and intensities for a heating task. In certain approaches, the panel could be implemented on the display via the use of a touch or gesture recognition display. The panel can also be implemented separately from the display using such technologies. The touch recognition for the panel could be implemented with a capacitive touch sensor. The gesture recognition technology could be implemented using sonar, ultrasound, visible light, infrared, or ultraviolet sensing. The electronic oven could also include a visible light camera for reading QR codes or 2D bar codes to obtain information regarding specific heating tasks. The camera could also identify items placed into the field of view of the camera using traditional classifier and image recognition techniques. The electronic oven could also include a microphone for receiving audio commands from a user. The electronic oven could also include a speaker for providing auditory prompts to the user. The speaker and microphone could be used in combination to carry out a conversation with the user.

The electronic oven could also be augmented with a network connection. The connection to the network could be wired or wireless. For example, the oven could include a radio for a cellular, satellite, or Wi-Fi connection. The electronic oven could include a web client for communication with external web services. The control system for the electronic oven could include a web browser or simple HTTP client for communicating over the Internet via that radio. The wireless communication system and control system could also be configured to communicate over a LAN or PAN such as through the use of Bluetooth, Zigbee, Z-wave or a similar standard. The radio could also be configured to conduct inductive communication with RFID tags placed on the packaging of items to be heated. The inductive communication could be NFC communication.

The electronic oven could communicate via any of the aforementioned means to a central server administrated by or on behalf of the manufacturer of the electronic oven to receive updates and provide information on the machine's operation. All of the functionality provided by the user interface components of the electronic oven could be provided by a separate external consumer device such as a mobile telephone or web portal on a workstation via any of the aforementioned means. Communication could include providing status information from the oven to the device or commands from the device to the oven. Additional functionality may be provided to the external device given the potential for the device and oven to be in separate places (e.g., more frequent status updates or a visible light image of what is in the chamber).

The electronic oven could also include a control system built into the electronic oven. The control system could be located on one or more printed circuit boards and could comprise one or more integrated circuits. The control system could include a processor. The control system could also include a non-transitory computer readable medium. The non-transitory computer readable medium could include numerous electronic memory devices scattered among the various components of the control system such as the ROM or firmware of different integrated circuits in a chip set or nonvolatile memories connected to external processors via a bus or leads on a printed circuit board. The non-transitory computer readable medium could store instructions for the execution of actions conducted by the electronic oven in accordance with this disclosure. The non-transitory computer readable medium could also store values and data needed for the execution of those actions.

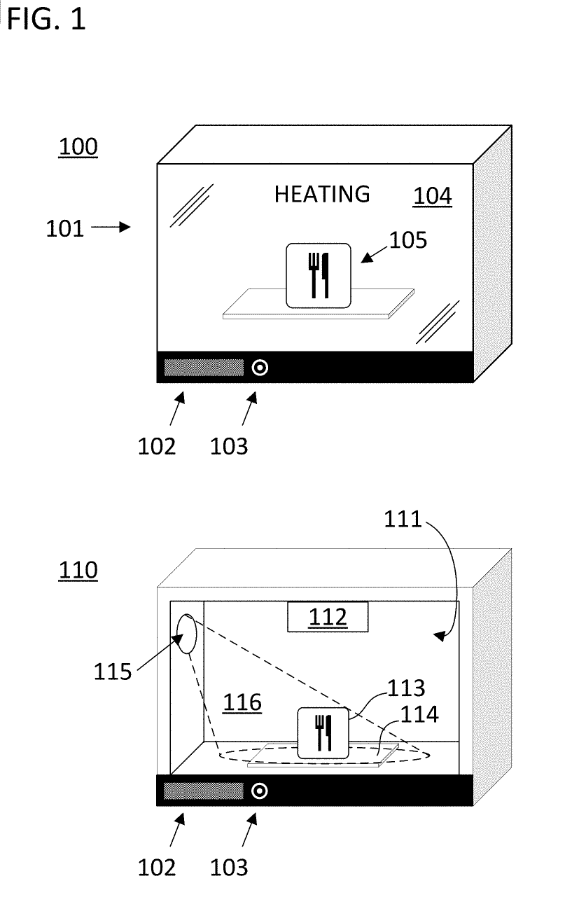

FIG. 1 illustrates an electronic oven in a closed state 100 and in an open state 110. A chamber door 101 of the electronic oven has been removed in open state 110 to provide an illustration of the electronic oven's heating chamber 111. The heating chamber could receive energy from an electronic energy source 112 that creates a wave pattern in the heating chamber. The wave pattern could be used to heat item 113. As illustrated, item 113 is located on a tray 114. The electronic oven could be capable of moving tray 114 by rotating the tray around a central axis or by translating the tray in any or all of six potential directions including up, down, left, right, back and forward.

FIG. 1 also illustrates user interface elements for the electronic oven. The electronic oven includes speaker 102 and microphone 103 that are accessible in both closed state 100 and open state 110. The electronic oven also includes a touch display 104. In the illustrated implementation, touch display 104 is located on chamber door 101. A touch display, such as touch display 104, could alternatively have been placed next to the chamber door so that it is accessible when the chamber door is closed or open. In addition, the touch display 104 could be replaced with a regular display so long as a different channel was provided for receiving input from the user such as via microphone 103, an external consumer device, or a gesture recognition system.

In the illustrated example, touch display 104 is currently displaying an image 105 of item 113. The image could be provided in real time as it is obtained from a light sensor with a field of view of the interior of heating chamber 111. For example, a light sensor 115 built into a wall of heating chamber 111 could have a field of view 116 of at least a portion of heating chamber 111. The portion of the heating chamber could then be displayed as image 105 on touch display 104 using information obtained from light sensor 115. Light sensor 115 could be a visible or infrared light sensor. An electronic oven in accordance with this disclosure could alternatively have both types of light sensors and a single sensor could be configured to sense both forms of light. The image 105 could provide a heat map of item 113 through the use of the infrared light sensor with different colors being displayed by image 105 to represent the distribution of heat across a surface of the item. A user could be able to switch image 105 between an image of the visible light and an image of the infrared light.

An electronic oven in accordance with certain approaches in this disclosure can utilize various display layouts for providing information to a user. In the approach in FIG. 1, the display took up an entire surface of the electronic oven. However, the display could only take up a portion of one surface of the electronic oven while another portion of that same surface was reserved for another display or a physical control panel. The display could also be divided into sections where one section was reserved for displaying an image of the item while another section was reserved for a touch or gesture recognition control panel. The display could display an image of the item from various perspectives. The image of the item could be turned on and off by the user to allow the display real estate to be used to provide other outputs to the user.

The display could also be translucent such that the actual item could be viewed through the display while additional information was overlain on the item and other portions of the display. A surface of the electronic oven could include both a translucent display and a traditional touch screen side by side. A translucent portion of the display can allow visible light to exit the heating chamber while an imaging portion of the display provides either information from the light sensor or other information to a user of the electronic oven. The additional information could include a guide for an adjustment to the item to allow for more efficient heating, highlighting a particular sub-item for identification, or highlighting a particular sub-item to request a heating command from the user.

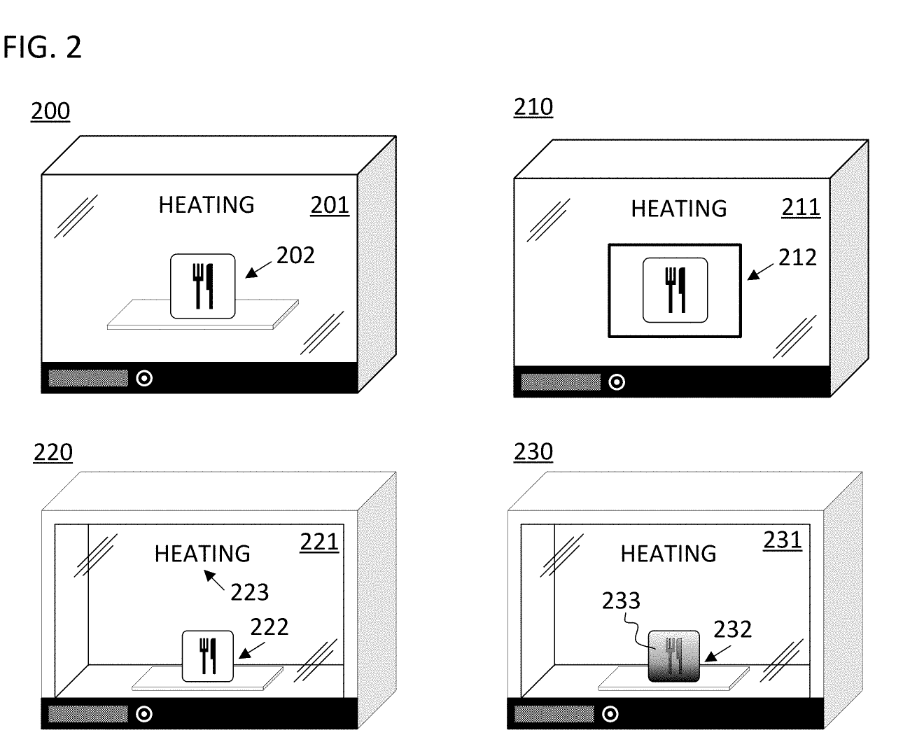

FIG. 2 illustrates various alternative approaches to the display of information concerning the item on a display of an electronic oven. Electronic oven 200 is in keeping with the approach disclosed above in that a perspective view 202 of the item is provided on display 201. The perspective view could be configured to show the item as if the chamber door were not present. However, based on the location of the image sensor, different views of the item could be provided. An example of a different view of the item that could be provided is shown by electronic oven 210 in which the item is shown in a plan view 212 on display 211. If multiple light sensors were provided, or the item is moved within the chamber, different views of the item could be provided by the display. A user could be provided with multiple views at the same time or the ability to cycle through different views. In addition, multiple cameras or information processing approaches could be applied to make an item appear stationary in the image on the display even though the item was being moved within the chamber. Approaches 200 and 210 have an advantage over traditional approaches in this regard in that they require fewer discontinuities in the chamber wall to allow visible light to escape the chamber, which simplifies the design requirements of the electronic oven.

Electronic ovens 220 and 230 represent a different approach in which the displays 221 and 231 are translucent. As illustrated, it is possible to see items 222 and 232 through the display. However, information 223 is still provided on the display on an imaging portion of the display. The imaging portion could overlap the translucent portion where different segments of the imaging portion could alternate between being translucent and displaying light to an observer. Furthermore, information such as a heat map 233 could be provided on the display over item 232 to make it appear as if the information and item were physically connected. Although visible light would be able to pass through display 221 and 231 in these situations, the chamber door could still be augmented to block microwave energy from escaping the chamber. For example, the door could be generally translucent except for a metal screen used to block the microwave energy. Regardless of whether an actual view of the item or an image of the item is displayed, the item could be overlain with information regarding the current heating task and could be used to exchange information between the user and the machine to facilitate the hybrid heating approaches disclosed herein. Specific methods for facilitating this communication are provided below.

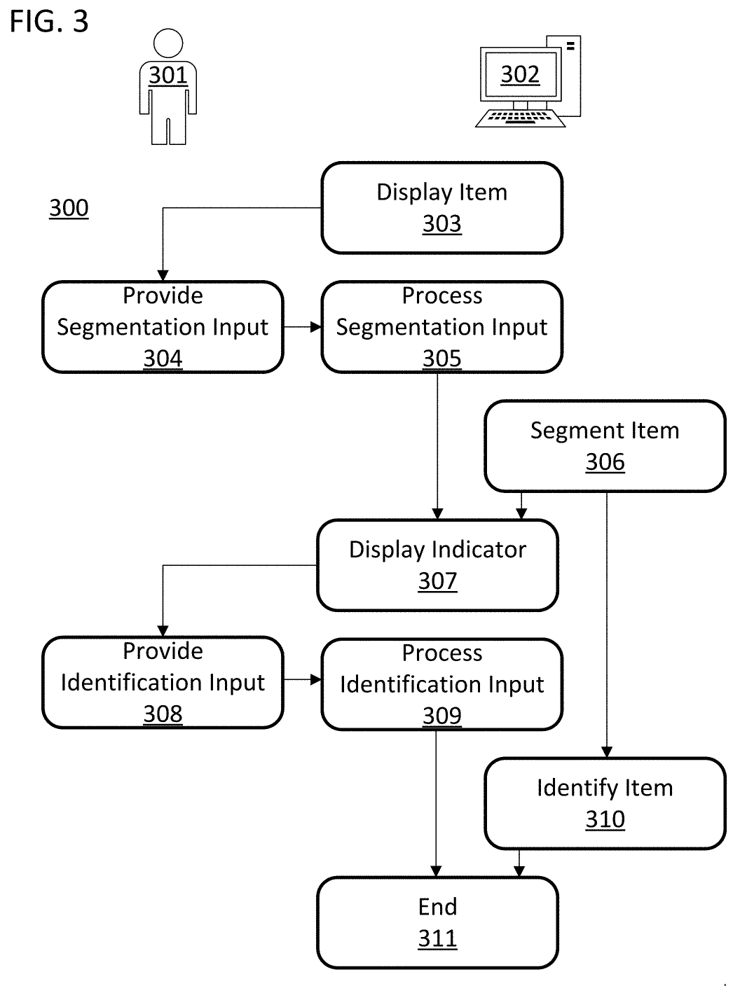

FIG. 3 includes a flow chart 300 of a set of methods for hybrid man-machine segmenting and identifying of an item in an electronic oven. These approaches can be facilitated by the user interface controls described above with reference to FIGS. 1 and 2. Steps on the far left of the page of FIG. 3 are conducted by user 301. Steps in the center of the page involve communication between user 301 and computer 302. Steps on the far right are conducted by computer 302. The computer could be the control system of the electronic oven as described in this specification. The disclosed methods can begin with step 303 in which computer 302 executes instructions stored on a non-transitory computer readable medium to display the item on a display. The item can be displayed as an image on the display. The item can be displayed along with a portion of the heating chamber of the electronic oven as an image on a display. Alternatively, the item can be visible through a translucent portion of the electronic oven as described above, and can thereby displayed by the electronic oven simply by having the item be viewable via that translucent portion. Displaying the item allows for the computer and human to have a common reference point for additional interactions. In approaches in which the display of the electronic oven is a touch display or is augmented with a gesture recognition technology, the additional interactions can involve the computer processing a touch input on the image or a gesture directed to the image.

Numerous steps in flow chart 300 are redundant in that many of the tasks associated with segmenting and identifying an item in the electronic oven can be executed by either the human user or the machine. For example, step 304 involves the user providing a segmentation input 304 and the computer processing the segmentation input 305. However, neither of these steps are necessary if the computer executes step 306 and segments the item automatically. Likewise, the steps of displaying an indicator 307, providing an identification input 308, and processing the identification input 309 are not necessary if the computer executes step 310 and identifies the item automatically. In any situation, the methods of flow chart 300 will terminate at step 311 when the item has been identified to the electronic oven. Automatic identification and segmentation of the item as in steps 306 and 310 can be done using information from a light sensor with a field of view of the heating chamber and a classifier. A set of weights for the classifier can be stored in a memory of the electronic oven and can be updated from a central server. In approaches in which user inputs are provided for segmentation or identification, the user inputs can be used to train the weights for the classifier or to train the electronic oven's machine intelligence components more generally. A combined approach is also possible in which the electronic oven will execute automatic segmentation and identification processes, but will also provide the user with the ability to correct the machine algorithm and therefore provide additional training data. Regardless of whether the approach involves fully automatic identification and segmentation with the ability for the user to enter a double check, or a manual identification and segmentation, any input from the user can be collected to obtain training data for the control system to learn how to segment and identify items.

The identity of the item as derived by the methods of flow chart 300 can be used to initialize a planner for the execution of a heating task or to develop a plan for the execution of that heating task. The user can be given the opportunity to provide additional information at that stage also. In other words, the planning and execution of the heating task can also be conducted in a fully autonomous or hybrid manner. For example, the user could use the identity of the item in combination with a command to instruct the electronic oven to heat a specific sub-item in a given way. For example, the user could be able to provide a command such as “cook the chicken for 2 minutes” or “cook the chicken for 5 minutes” to instruct the electronic oven how to cook a specific item in the electronic oven. Furthermore, the identity of the item could be used in combination with a command to heat the item with less manual control over the heating task. The user could provide a one word instruction for the heating task without the need to manually set a time and/or heat level for the cooking task. For example, the user could say “reheat the chicken” or “cook the chicken” to instruct the electronic oven to select a plan for reheating or cooking the item based on its identity. The machine could then utilize knowledge of the item's characteristics to select various parameters such as heat application durations and intensities that would achieve the requested type of heating for the item. The user may also be able to provide commands for heating different sub-items differently during the same heating task according to their identities. For example, the user may be able to instruct the electronic oven to reheat a portion of a meal while cooking another portion of the meal on the same plate.

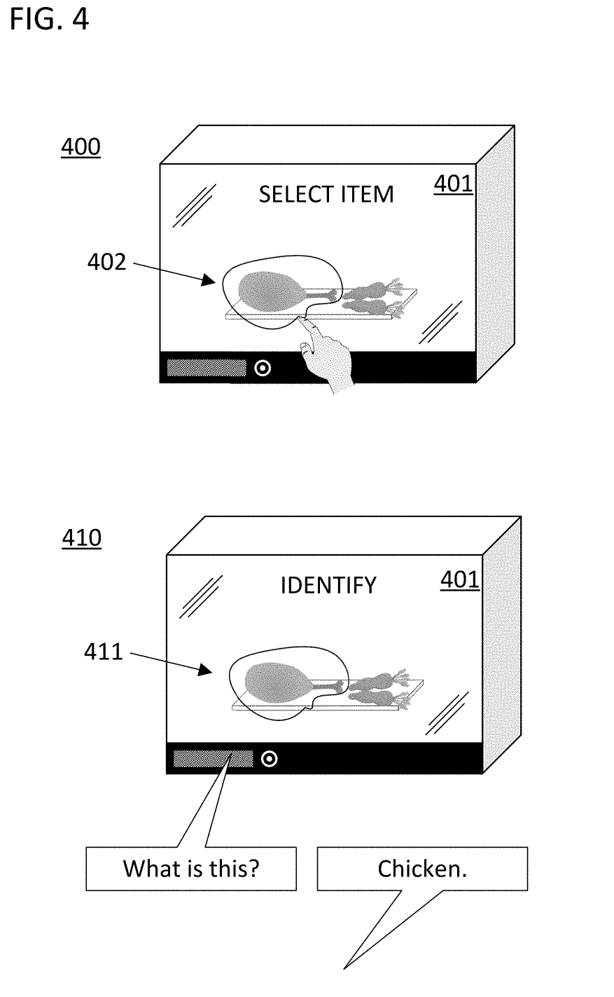

FIG. 4 illustrates a specific implementation of one of the methods illustrated by FIG. 3. FIG. 4 includes an electronic oven in two different states at two different points in time. States 400 and 410 provide an example of an electronic oven executing a method that includes step 303, 304, 305, 307, 308, and 309. Portions of this approach can be used with other methods in which steps 306 or 310 are substituted for an equivalent execution by the user in combination with the computer.

In state 400, touch display 401 receives a trace input 402 on an image on the display which serves as the execution of step 304. The trace input forms a path. The path can be an encircling path around an item. The trace input does not need to form a perfect closed path around the item (e.g., an encircling path may cover less than a full circle and the start and end might not coincide). The path needs to surround the item sufficiently to distinguish it from other items. The electronic oven could close the start of the trace input to the end of the trace input using a straight line for form the selected area. The trace input is provided in response to a prompt asking the user to select an item. The prompt “select item” was provided visually on display 401 in this example by a user tracing the item with their finger, but could have been provided via an auditory channel. State 400 shows an example of the execution of step 304 because the user has identified a sub-item in the chamber and has therefore segmented the item in the chamber. In response, the electronic oven will process the segmentation input as in step 305 which could involve tagging a portion of the image with segmentation data or associating a tag with a physical location within the electronic oven. As stated previously, the response could also involve saving the segmentation input and the image of the item as training data for a classifier.

In state 410, a selection indicator 411 is displayed on the item on touch display 401. In the illustrated case, the selection indicator is the same shape as the trace input. However, the selection indicator could include a change in color or emphasis from the trace input to indicate that the trace input was successfully received. The selection indicator could also be an arrow or icon placed on the center of the trace input to provide a less cluttered display. Alternatively, a selection indicator could be displayed on the item after the item was automatically identified using a classifier. Other visualizations of the selection indicator are possible—such as different geometries or graphics. For example, the indicator could be an arrow pointing to a specific item, a start or dot placed on the item, a highlight around a boarder of the item, a highlight covering the item, or any other visual indication biasing an observer towards a portion of the image.

Touch inputs or gestures directed to the display of portions of the heating chamber or discretely presented items could be used to allow a user to segment or select items or sub-items in the electronic oven. Selection of an item could be conducted in furtherance of a discussion between the electronic oven and the user regarding an identity of the sub-item, or commands or instructions that are specific to a single sub-item in the electronic oven. These inputs do not need to serve to segment the item, as the item could be segmented using machine intelligence. For example, machine intelligence algorithms could segment the item automatically, and a user could select a specific sub-item by touching or gesturing towards any portion of the item on the display. A selection indicator such as selection indicator 411 would then appear over the item as pulled from memory and initially generated by the machine intelligence algorithms.

Regardless of how the initial segmentation and selection occurs, a prompt could be provided by a speaker of the electronic oven or a visual prompt could be provided by the display to identify or confirm the sub-item or provide further instructions while the sub-item was selected. As illustrated in state 410, both a visual prompt via the display and auditory prompt via the speaker (“What is this?”) are provided to request identification information while the sub-item is selected. In response, the electronic oven could receive a command or identification information from the user via a touch input, gesture input, or microphone. The electronic oven could then associate the item with the command or identification information in a memory. Alternatively, the electronic oven could associate a location in the electronic oven with the command or identification information. In the illustrated example, an auditory response to the prompt is provided to identify the item as chicken. Selection indicator 411 can be displayed both while the prompt is delivered, and the response is provided. Also, instead of a selection indicator, the image of the item can be presented such that only the item is visible so that a selection indicator was not needed in order for the machine and user to have an understanding as to the topic of their ongoing interaction. Finally, in approaches in which the actual item is revealed via a transparent portion of the electronic oven, a remainder of the heating chamber could be placed behind a non-transparent portion of the electronic oven such that a selection indicator was not needed.

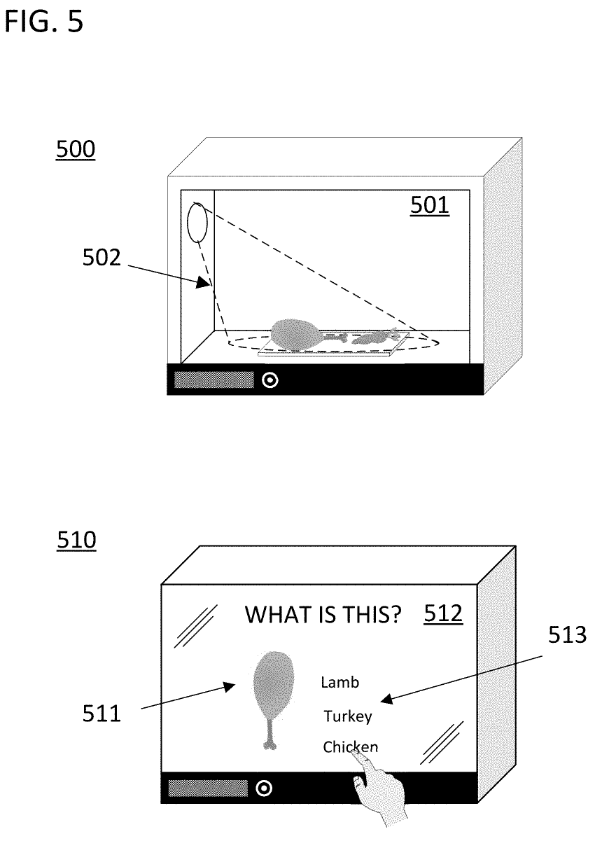

Numerous variations of the approaches in FIG. 3 can be executed with different degrees of human participation and automation with machine intelligence. For example, FIG. 5 illustrates a more automated procedure that depends on more sophisticated machine intelligence algorithms. FIG. 5 displays two views of an electronic oven. In view 500 the chamber door to the heating chamber has been removed from the illustration to provide a view of heating chamber 501. As shown, the item in the heating chamber is within the field of view of a light sensor 502. The electronic oven utilizes the light provided to the light sensor to segment the item, and runs the segmented data through a classifier to generate potential identification information for the item. The classifier could then take a best guess at what the item was, and request a cooking instruction for the item from the user. However, the classifier could also present a few likely identities of the item to the user. For example, an image of the item 511 could be presented on a display 512 along with a list 513 of likely identities for the item. The user could then be prompted to provide identification information to the electronic oven in the form of a touch or gesture input towards one of the items on list 513. In this situation, the electronic oven has both segmented and partially identified a sub-item in the electronic oven with little human intervention.

Upon completion of the identification and segmentation phases, the machine intelligence approaches could also automatically plan a meal and cook the food. However, some input from the user may still be beneficially accepted. For example, the identification step could be used to pull item-specific data for generating a proper heating plan while human input was optionally used to provide the subjective needs of that particular user in terms of their heating preferences. Upon identifying an item as a cup of tea, the control system could present a user with the option to have warm or hot tea. Upon identifying an item as a steak, the control system could present the user with the option to have a well done or medium rare steak.

The identification and segmentation phases could be executed multiple times for different sub-items. As in either of the situations illustrated by FIG. 4 and FIG. 5, another tour through the flow would allow a user to segment and identify the carrots so that they could be cooked differently. The entire loops of segmenting and identifying items could be repeated any number of times for all of the sub-items that are in the electronic oven. After identifying the items, separate heating commands could be given for each of a first item and a second item that comprise sub-items of the overall item in the electronic oven. The first item and the second item could be located in the heating chamber at the same time. The electronic oven could then heat the two items separately such as by heating a first portion of the heating chamber and a second portion of the heating chamber simultaneously but with different energy conditions from each other.

As with the individual steps, the decision to execute another loop, or to cease looping can also be conducted by either the user or the control system. Looping steps 303-305 could involve prompting the user at the end of step 304 to either provide additional segmentation inputs or to indicate that the item in the electronic oven was fully segmented. As such, the user would be in control of the decision to execute another loop. Alternatively, steps 303-305 could loop with the assistance of a machine intelligence system that presented rough estimates of segmented items to the user for more refined segmentation inputs and ceased looping automatically once the item was properly segmented. As such, the control system would be in control of the decision to execute another loop. In situations in which segmentation and identification are separately looped, the number of times the identification steps would be looped could be easily controlled by the control system in that each segmentation loop would have generated another sub-item for which identification was required. In this class of approaches, looping steps 307-309 would involve presenting the user with a sequence of segmented sub-items, as derived in step 306 or through a loop of steps 303-305, and prompting the user for an identification input for each of them in series.

In the methods of FIG. 3 that are not fully automated, the human input can be used to train a classifier for the electronic oven. Additionally, even when an implementation of FIG. 3 is fully automated, prompts can be provided to the user to confirm that the machine intelligence system had executed the segmentation and identification properly. Responses to the prompts can be optional or can gate the performance of a heating task. Regardless, human input regarding segmentation and identification can be used as training data for the machine intelligence algorithms on the electronic oven or other electronic ovens via the uploading of that data to a network. The same electronic oven can also use different combinations of human inputs and machine intelligence over the course of its life as it uses the human input to improve the performance of its machine intelligence systems. In some approaches, the training data can be for aspects of the machine intelligence algorithms that are specific to a given user such that the electronic oven is specifically trained for the subjective preferences of its user.

In certain approaches, the electronic oven may request assistance from the user to execute a given heating task. Although the electronic oven may be augmented with specific technologies for heating complex items in the chamber, such as by moving a pattern of energy distribution in the chamber, the hardware requirements of the electronic oven can be greatly alleviated by not having to prepare for every potential combination of items that can be placed in the chamber. To this end, the electronic oven can provide a prompt to the user to conduct such actions as moving the relative position of the item or sub-items in the chamber, removing the item from the chamber and stirring the item, or applying other ingredients to the item (e.g., adding a tablespoon of water to an item). The prompt can be provided via auditory or visual means. In a particular example, the prompt will be provided via visual information overlain on an image of the item.

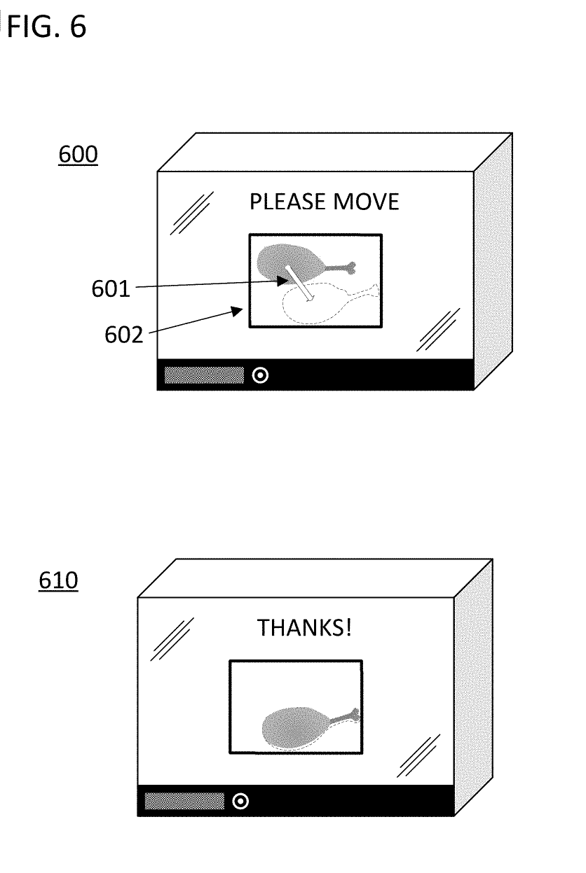

FIG. 6 provides a specific example of how a prompt for human assistance can be provided by the electronic oven. FIG. 6 illustrates the same electronic oven in two states 600 and 610 that are separated in time with state 610 occurring after the instruction for human assistance has been complied with. As illustrated, an instruction is provided to the user by overlaying the instructions on a visible representation of the item itself. In this particular case, the instruction includes a guide 601 (in the form of an arrow and an outline for a new position) and textual instructions provided on the display to move the item as indicated. Representation 602 is provided via a plan view of the item obtained by a light sensor in the chamber. However, similar instructions and guides can be provided over other views of the item including views of the item through a transparent portion of the heating chamber. In the illustrated example, the visible light sensor can be used to monitor the item after the prompt has been made and allow the heating task to continue after the instruction has been complied with. As shown in state 610, the item has been moved to the new location as instructed and the electronic oven will continue with the heating task. The human intervention will have led to a more expeditious and potentially better overall execution of the current heating task.

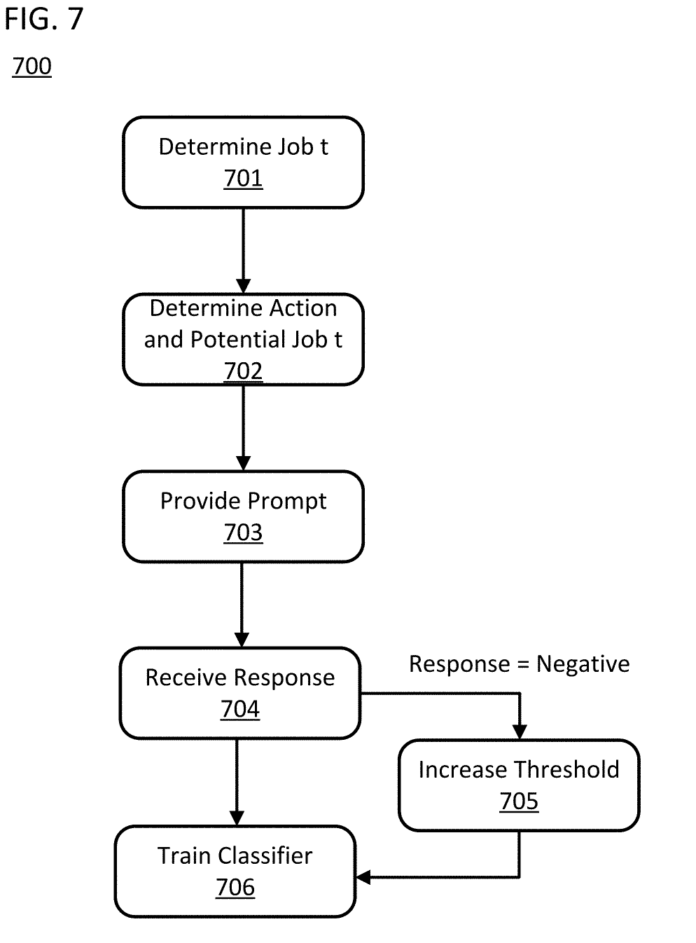

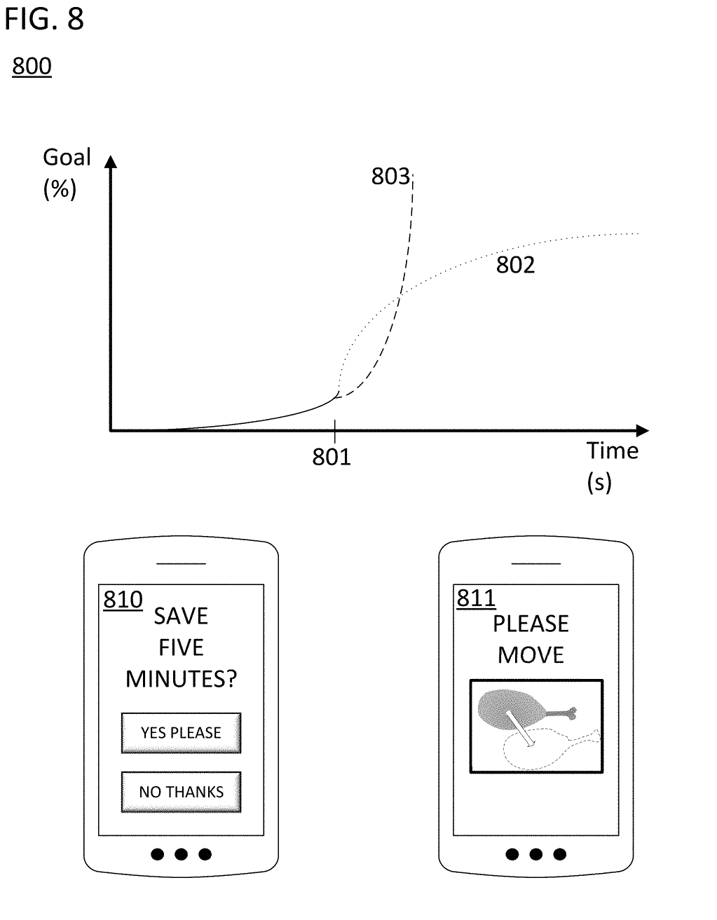

Although human intervention may lead to a faster execution of a heating task, the electronic oven can be trained to avoid interrupting the user and requesting assistance if the benefit of the faster execution of the heating task does not outweigh the cost associated with the human assistance. Generally, the electronic oven can include instructions to execute a set of methods provided by flow chart 700 in FIG. 7. The flow chart illustrates how the electronic oven will determine the need for human intervention and learn what degree of interruption a human user will tolerate. Execution of at least one of the methods represented by the flow chart can be described with reference to the set of axes 800 and images of smartphone user interfaces 801 and 802 in FIG. 8. The abscissa of the set of axes 800 is in units of time and the ordinate of the set of axes 800 is in units of %. User interfaces 810 and 811 are presented on the same user device at different times with user interface 811 presented subsequent to the presentation of user interface 810. Although user interfaces 810 and 811 are presented in FIG. 8 on a smartphone, other external user devices are possible such as a laptop, a tablet, a smart watch, or other devices.

Flow chart 700 begins with step 701 of determining a remaining job time. The remaining job time can be an estimate of the time required to execute a given heating task. Step 701 could be executed at time 801 and could involve projecting line 802 based on a physics simulator or other heuristic for estimating the remaining time for executing the heating task without human intervention. The flow chart continues with step 702 of determining a potential human interaction and a potential remaining job time. Although the steps are shown in sequence, their chronological relationship is not fixed. However, the execution of step 702 could be predicated on the remaining job time calculated in step 701 exceeding a threshold. The threshold could be a fixed time or could be set based on an identity of the item being heated, the heat delivered to the chamber so far during the heating task, and other factors. Step 702 could likewise be executed at time 801 and could involve projecting line 803 based on the same systems and methods mentioned above except that the projection assumes that the potential human interaction occurs.

Flow chart 700 continues with step 703 of providing a prompt for assistance if the remaining job time calculated in step 701 exceeds the potential remaining job time calculated in step 702 by more than a threshold. This threshold can also be a fixed time or could be set based on an identity of the item being heated, the heat delivered to the chamber so far during the heating task, and other factors. The prompt can be provided on the electronic oven or other external user device. The prompt can also be delivered to both devices, or just one based on a determination as to a likely location of the user. The determination can be based on location information from the smartphone and motion sensors on the electronic oven. The prompt can be a specific request for assistance, or it can gauge the user's interest in providing such assistance. For example, either user interface 810 or 811 in FIG. 8 could be provided to the user to allow input during the execution of step 703. As illustrated, the user interface is provided to an external user device—in this case a smartphone. The threshold can be configured based on a relative location of the smartphone and the electronic oven and an indication that the smartphone is being physically carried by the user (i.e., the threshold can be higher if the smartphone is further away from the electronic oven).

Flow chart 700 continues with step 704 of receiving a response from the prompt. In the case of user interface 810, the response could be provided via a press of the “yes please” button or the “no thanks” button. The flow chart could then continue with step 705 in the case of a negative response in which the threshold for prompting the user was increased for all other conditions held equal. Regardless of whether the response was positive or negative, the flow chart could also continue with step 706 in which a classifier for determining when to prompt the user was trained using the response and the threshold as inputs.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a non-transitory computer-readable medium storing instructions for those method steps. The computer-readable medium may be a memory within the electronic oven or a network accessible memory. As mentioned above, the memory could include multiple distributed physical memories in the electronic oven. Although examples in the disclosure included heating items through the application of electromagnetic energy, any other form of heating could be used in combination or in the alternative. The term “item” should not be limited to a single homogenous element and should be interpreted to include any collection of matter that is to be heated. For the avoidance of doubt, a meal involving two or more different types of food, such as the chicken and carrots in FIG. 4, constitutes a single “item” in the language of this disclosure. These and other modifications and variations to the present invention may be practiced by those skilled in the art, without departing from the scope of the present invention, which is more particularly set forth in the appended claims.

What is claimed is:

1. An electronic oven, comprising:
a touch display;
a heating chamber for heating an item in the electronic oven;
a light sensor having a field of view, wherein at least a portion of the heating chamber is in the field of view;
a microwave energy source coupled to the heating chamber; and
a non-transitory computer-readable medium that stores instructions to:
display the portion of the heating chamber as an image on the touch display using information from the light sensor; and
process a touch input on the image;
wherein the light sensor is one of an infrared light sensor and a visible light sensor.

2. The electronic oven of claim 1, further comprising:
a heating chamber door that seals the heating chamber for heating and opens the heating chamber for allowing access to the heating chamber;
wherein the touch display is located on the heating chamber door.

3. The electronic oven of claim 1, wherein the non-transitory computer-readable medium stores instructions to:
receive a trace input on the image on the touch display, wherein the trace input forms an encircling path; and
display a selection indicator on an item on the touch display in response to receiving the trace input, wherein the encircling path surrounds the item on the touch display.

4. The electronic oven of claim 3, further comprising:
a microphone;
wherein the non-transitory computer-readable medium stores instructions to:
receive a command via the microphone while the selection indicator is displayed; and
associate the item in the electronic oven with the command in a memory in response to receiving the command while the selection indicator is displayed.

5. electronic oven of claim 3, wherein the non-transitory computer-readable medium stores instructions to:
train a machine intelligence system using at least a portion of the image and the trace input.

6. The electronic oven of claim 3, wherein the non-transitory computer-readable medium stores instructions to:
receive an identity of the item while the selection indicator is displayed; and
associate at least a portion of the image with the identity in a memory.

7. The electronic oven of claim 6, wherein the non-transitory computer-readable medium stores instructions to:
train a classifier using the portion of the image and the identity.

8. The electronic oven of claim 1, wherein the non-transitory computer-readable medium stores instructions to:
automatically identify the item in the electronic oven in the portion of the chamber using information from the light sensor and a classifier, wherein a set of weights for the classifier are stored on the non-transitory computer-readable medium; and
display a selection indicator on an item on the touch display after the item on the touch display is automatically identified using the classifier;
provide a prompt for a heating command while the selection indicator is displayed; and
associate the item with the heating command in a memory in response to receiving the heating command while the selection indicator is displayed.

9. The electronic oven of claim 8, further comprising:
a speaker; and
a microphone;
wherein the non-transitory computer-readable medium stores instructions to:
provide the prompt for the heating command via the speaker while the selection indicator is displayed; and
receive the heating command using the microphone.

10. The electronic oven of claim 1, wherein the non-transitory computer-readable medium stores instructions to:
determine a remaining job time;
determine a potential human interaction and a potential remaining job time; and
provide a prompt for assistance if the remaining job time exceeds the potential remaining job time by more than a threshold;
wherein the potential remaining job time is an estimate of the remaining job time if the potential human interaction occurs.

11. The electronic oven of claim 10, wherein the non-transitory computer-readable medium stores instructions to:
receive a negative response in response to the prompt for assistance; and
increase the threshold based on the negative response.

12. The electronic oven of claim 1, wherein the non-transitory computer-readable medium stores instructions to:
display a guide on the image on the touch display;
wherein the guide is for an adjustment to a position of the item.

13. The electronic oven of claim 1, further comprising:
a heating chamber door that seals the heating chamber for heating and opens the heating chamber for allowing access to the heating chamber;
a translucent portion of the display that allows visible light to exit the heating chamber; and
an imaging portion of the display that displays one of: (i) information from the light sensor; and (ii) a guide for an adjustment to a position of the item in the electronic oven.
wherein the display is located on the heating chamber door;
wherein the imaging portion of the display overlays the translucent portion of the display; and
wherein the light sensor is the infrared light sensor.

14. The electronic oven of claim 13, wherein:
the guide includes a directional arrow extending from the item to a different location in the heating chamber.

15. A method for identifying an item in a heating chamber of an electronic oven, wherein each step is conducted by a controller of the electronic oven, the method comprising:
receiving information from a light sensor, wherein the light sensor has a field of view, and wherein the field of view includes at least a portion of the heating chamber;
segmenting an item in the heating chamber using the information from the light sensor;
displaying a selection indicator on the item using a display;
generating, while the selection indicator is displayed, a prompt for one of: (i) an identification of the item; and (ii) a heating instruction for the item;
receiving a response to the prompt; and
storing the response in association with a location in the heating chamber in a memory.

16. The method of claim 15, further comprising:
displaying a plan view image of the item on the display using the information from the light sensor;
wherein the selection indicator is displayed on the plan view image; and
wherein the display is located on a heating chamber door that seals the heating chamber for heating and opens the heating chamber for allowing access to the heating chamber.

17. The method of claim 15, further comprising:
revealing, on the display, the item in the heating chamber via a translucent portion of the display that allows visible light to exit the heating chamber; and
displaying the selection indicator on an imaging portion of the display;
wherein the display is located on a heating chamber door that seals the heating chamber for heating and opens the heating chamber for allowing access to the heating chamber.

18. The method of claim 15, further comprising:
displaying the information from the light sensor on the item using the imaging portion of the display.

19. The method of claim 15, wherein:
the prompt is an audio prompt provided by a speaker; and
the response is an audio response provided to a microphone.

20. The method of claim 15, wherein:
the display is a touch display;
the prompt is a visual prompt provided on the display; and
the response is a touch response provided on the touch display.

21. The method of claim 15, further comprising:
segmenting a second item in the heating chamber using the information from the light sensor; and
displaying a second selection indicator on the second item using the display;
wherein the first item and the second item are located in the heating chamber at the same time.

22. A method for identifying an item in a heating chamber of an electronic oven, wherein each step is conducted by a controller of the electronic oven, the method comprising:
receiving a trace input on a touch display, wherein the trace input forms an encircling path;
displaying a selection indicator on the touch display over a portion of the heating chamber based on the encircling path;
generating, while the selection indicator is displayed, a prompt for one of: (i) an identification of the item; and (ii) a heating instruction;
receiving a response to the prompt; and
storing the response in association with the portion of the heating chamber in a memory.

23. The method of claim 22, further comprising:
displaying a plan view image of the item on the display using the information from a light sensor;
wherein the selection indicator is displayed on the plan view image; and
wherein the display is located on a heating chamber door that seals the heating chamber for heating and opens the heating chamber for allowing access to the heating chamber.

24. The method of claim 22, further comprising:
revealing the item on the touch display via a translucent portion of the touch display that allows visible light to exit the heating chamber; and
displaying the selection indicator and the trace input on an imaging portion of the touch display;
wherein the touch display is located on a heating chamber door that seals the heating chamber for heating and opens the heating chamber for allowing access to the heating chamber.

25. The method of claim 22, wherein:
the prompt is an audio prompt provided by a speaker; and
the response is an audio response provided to a microphone.

26. The method of claim 22, wherein:
the prompt is a visual prompt provided on the display; and
the response is a touch response provided on the touch display.

27. The method of claim 22, further comprising:
receiving a second trace input on the touch display, wherein the second trace input forms a second encircling path;
displaying a second selection indicator on the touch display over a second portion of the heating chamber based on the second encircling path;
generating, while the second selection indicator is displayed, a second prompt for a second heating instruction; and
heating the first portion of the heating chamber and the second portion of the heating chamber simultaneously but differently from each other in accordance with the heating instruction and the second heating instruction.

28. The method of claim 22, further comprising:
segmenting the item using the trace input;
wherein displaying the selection indicator on the touch display involves displaying the selection indicator on the item.

29. The method of claim 28, further comprising:
storing an image of the item; and
training a machine intelligence system to segment using the trace input and the image.

30. The method of claim 28, further comprising:
heating the portion of the heating chamber in accordance with the heating instruction;
wherein heating the portion of the heating chamber is conducted using information from an infrared light sensor.

31. A method for heating an item in a heating chamber of an electronic oven, wherein each step is conducted by a controller of the electronic oven, the method comprising:
determining a remaining job time for heating the item in the heating chamber;
determining a potential human interaction and a potential remaining job time; and
providing a prompt for assistance if the remaining job time exceeds the potential remaining job time by more than a threshold;
wherein the potential remaining job time is an estimate of the remaining job time if the potential human interaction occurs.

32. The method of claim 30, further comprising:
receiving a response from the prompt;
training a classifier using the response and the threshold.

33. The method of claim 30, further comprising:
receiving a negative response to the prompt for assistance; and
increasing the threshold based on the negative response.

34. The method of claim 30, further comprising:
displaying an image of the item on a display using information from a light sensor, wherein the light sensor has a field of view, and wherein the field of view includes a portion of the heating chamber; and
displaying a guide on the image on the display;
wherein the prompt includes the guide.
